(19) United States
(12) Patent Application Publication
(10) Pub. No.: US 2025/0335362 A1
(43) Pub. Date: Oct. 30, 2025

(54) SYSTEMS, METHODS, AND MEDIA FOR PROVIDING APPEND-ONLY CACHES

(71) Applicant: SK hynix NAND Product Solutions Corp., Rancho Cordova, CA (US)

(72) Inventors: Mariusz Barczak, Gdansk (PL); Wojciech Malikowski, Gdansk (PL); Lukasz Lasek, Gdynia (PL)

(21) Appl. No.: 18/645,047

(22) Filed: Apr. 24, 2024

(51) Int. Cl. G06F 12/0891; G06F 12/02; G06F 12/0817

(52) U.S. Cl. CPC G06F 12/0891; G06F 12/0292; G06F 12/0864; G06F 12/0866

(57) ABSTRACT

Mechanism include: storing first, second, and third entries in a cache; calculating an index value that corresponds to the entries; storing, in a first table location corresponding to the index value, first information identifying a first location of the first entry; storing, in a second table location corresponding to the index value, second information identifying a second location of the second entry; storing, in a linked-list corresponding to the index value, third information identifying a third location of the third entry; in response to a request to access the third entry, comparing the request to each of at least part of the first information, at least part of the second information, and at least part of the third information; determining that the request corresponds to the at least part of the third information; and retrieving data responsive to the request based on the third information.

### BACKGROUND

Caches are widely used to improve performance of computing systems when data needs to be stored and/or retrieved quickly.

Many caches are not designed to be implemented in non-volatile memory, such as NAND memory.

Accordingly, new mechanisms for implementing caches are desirable.

### SUMMARY

In accordance with some embodiments, mechanisms (including systems, methods, and media) for providing append-only caches are provided.

In some embodiments, a system is provided, the system, comprising: a memory; and a hardware processor at least configured to: store a first entry in a cache; store a second entry in the cache; store a third entry in the cache; calculate an index value that corresponds to each of the first entry, the second entry, and the third entry; store, in a first table location corresponding to the index value, first information identifying a first location of the first entry in the cache; store, in a second table location corresponding to the index value, second information identifying a second location of the second entry in the cache; store, in a linked-list corresponding to the index value, third information identifying a third location of the third entry in the cache; in response to a request to access the third entry in the cache, compare the request to each of at least part of the first information, at least part of the second information, and at least part of the third information; determine that the request corresponds to the at least part of the third information; and retrieve data responsive to the request based on the third information. In some of these embodiments, the index value is calculated based on a first logical block address of the first entry, the index value is calculated based on a second logical block address of the second entry, and the index value is calculated based on a third logical block address of the third entry. In some of these embodiments, the index value is calculated based on a hash function. In some of these embodiments, the cache comprises a plurality of chunks of memory and each of the plurality of chunks contains a plurality of entries, and wherein the hardware processor is further configured to erase a chunk on the cache in response to determining that the cache is determined to be at or above a given percentage full. In some of these embodiments, the first information includes a logical block address of the first entry and a physical block address of the first entry. In some of these embodiments, the first information further comprises a size of data for the first entry. In some of these embodiments, the first entry includes a logical block address of the first entry, data of the first entry, and a size of the data of the first entry.

In some embodiments, methods are provided, comprising: storing a first entry in a cache; storing a second entry in the cache; storing a third entry in the cache; calculating an index value that corresponds to each of the first entry, the second entry, and the third entry; storing, in a first table location corresponding to the index value, first information identifying a first location of the first entry in the cache; storing, in a second table location corresponding to the index value, second information identifying a second location of the second entry in the cache; storing, in a linked-list corresponding to the index value, third information identifying a third location of the third entry in the cache; in response to a request to access the third entry in the cache, comparing the request to each of at least part of the first information, at least part of the second information, and at least part of the third information, using a hardware processor; determining that the request corresponds to the at least part of the third information, using the hardware processor; and retrieving data responsive to the request based on the third information, using the hardware processor. In some of these embodiments, the index value is calculated based on a first logical block address of the first entry, the index value is calculated based on a second logical block address of the second entry, and the index value is calculated based on a third logical block address of the third entry. In some of these embodiments, the index value is calculated based on a hash function. In some of these embodiments, the cache comprises a plurality of chunks of memory and each of the plurality of chunks contains a plurality of entries, and wherein the method further comprises erasing a chunk on the cache in response to determining that the cache is determined to be at or above a given percentage full. In some of these embodiments, the first information includes a logical block address of the first entry and a physical block address of the first entry. In some of these embodiments, the first information further comprises a size of data for the first entry. In some of these embodiments, the first entry includes a logical block address of the first entry, data of the first entry, and a size of the data of the first entry.

In some embodiments, non-transitory computer-readable media containing computer executable instructions that, when executed by a processor, cause the processor to perform a method are provided, the method, comprising: storing a first entry in a cache; storing a second entry in the cache; storing a third entry in the cache; calculating an index value that corresponds to each of the first entry, the second entry, and the third entry; storing, in a first table location corresponding to the index value, first information identifying a first location of the first entry in the cache; storing, in a second table location corresponding to the index value, second information identifying a second location of the second entry in the cache; storing, in a linked-list corresponding to the index value, third information identifying a third location of the third entry in the cache; in response to a request to access the third entry in the cache, comparing the request to each of at least part of the first information, at least part of the second information, and at least part of the third information; determining that the request corresponds to the at least part of the third information; and retrieving data responsive to the request based on the third information. In some of these embodiments, the index value is calculated based on a first logical block address of the first entry, the index value is calculated based on a second logical block address of the second entry, and the index value is calculated based on a third logical block address of the third entry. In some of these embodiments, the index value is calculated based on a hash function. In some of these embodiments, the cache comprises a plurality of chunks of memory and each of the plurality of chunks contains a plurality of entries, and wherein the method further comprises erasing a chunk on the cache in response to determining that the cache is determined to be at or above a given percentage full. In some of these embodiments, the first information includes a logical block address of the first entry and a physical block address of the first entry. In some of these embodiments, the first information further comprises a size of data for the first entry.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is an illustration of an example of a cache in accordance with some embodiments of the disclosed subject matter.

FIG. 2 is an illustration of an example of a data structure for keeping track of entries in a cache in accordance with some embodiments of the disclosed subject matter.

FIG. 3 is a flow diagram of an example of a process for writing to a cache in accordance with some embodiments of the disclosed subject matter.

FIG. 4 is a flow diagram of an example of a process for accessing an entry in a cache in accordance with some embodiments of the disclosed subject matter.

FIG. 5 is a flow diagram of an example of a process for erasing a chunk of a cache in accordance with some embodiments of the disclosed subject matter.

FIG. 6 is a block diagram of example hardware that can be used in accordance with some embodiments of the disclosed subject matter.

### DETAILED DESCRIPTION

In accordance with some embodiments, mechanisms (including systems, methods, and media) for providing append-only caches are provided.

In some embodiments, append-only caches are provided in which data is stored in a circular cache implemented using chunks of memory. Each chunk can have any suitable size, in some embodiments. When space is required in the cache, the chunk with the oldest data can be erased, in some embodiments.

In some embodiments, a data structure for tracking entries in the cache can be implemented using a combination of a table and linked-lists. Each entry in the cache can be indexed using an index value that is based on a logical block address corresponding to the entry, in some embodiments. Because of collisions when calculating the index values for cache entries, a given index value can correspond to multiple different cache entries, in some embodiments. For each possible index value, the table can contain a fixed number of slots each capable of containing a logical block address, a physical block address, and a size of a corresponding cache entry having the index value, in some embodiments. Also, for each possible index value, the table can contain a pointer to a linked-list containing one or more entries containing a logical block address, a physical block address, and a size of a corresponding cache entry having the index value, in some embodiments. When there are more cache entries than the number of slots for a given index value, the cache entries can be stored in the linked-list, in some embodiments. In this way, the data structure can use a combination of table and linked-lists to track cache entries, in some embodiments. The mechanism described herein can maintain the data structure and use it to locate items in the cache, in some embodiments.

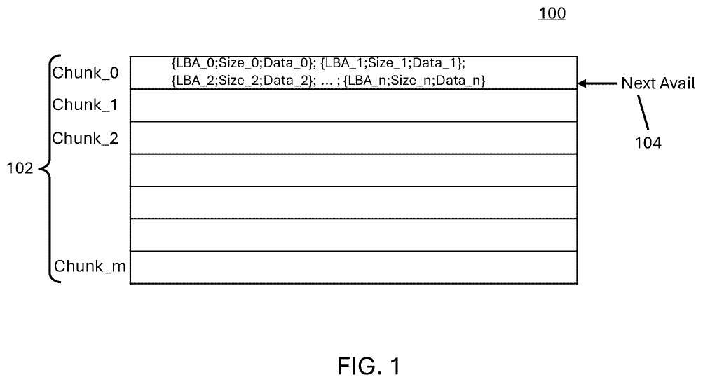

Turning to FIG. 1, an example illustration of a cache 100 in accordance with some embodiments is shown.

In some embodiments, the cache can be formed from any suitable type of physical memory, including but not limited to: Random Access Memory (RAM) (such as dynamic RAM, static RAM, etc.); NAND flash memory; NOR flash memory; any other suitable flash technology; phase change memory technology; and/or other any other suitable volatile and/or non-volatile memory storage technology. When using NAND flash memory, any suitable NAND technology can be used in some embodiments. For example, in some embodiments, NAND technologies such as single-level cell (SLC) NAND, multilevel cell (MLC) NAND, triple-level cell (TLC) NAND, quad-level cell (QLC) NAND, penta-level cell (PLC) NAND, or any NAND with suitable levels of cells can be used. In some embodiments, the NAND can be 2D NAND or 3D NAND. Each physical media can have any suitable size in some embodiments.

In some embodiments, the cache can be implemented as an append-only cache. As such, in some embodiments, each location in the cache can be written to the cache but not updated, and when an update to an entry is available, a new version of the entry is written to the cache and the old version of the entry is no longer used and/or erased.

As illustrated, in some embodiments, the cache can be implemented as a series of chunks 102, labelled in the FIG. 1 as chunk_0 through chunk_m. Each chunk can have any suitable size (e.g., such as one gigabyte, two gigabyte, four gigabyte, etc.), and there can be any suitable number of chunks (e.g., 8, 16, 32, etc.), in some embodiments.

Any suitable data and/or metadata can be stored in each chunk 102 of cache 100, and the data/metadata can have any suitable size, in some embodiments. For example, in some embodiments, an entry in a chunk 102 of cache 100 can include a logical block address for the entry, a size of the data in the entry, and the data of the entry. Such an entry can be illustrated as {LBA_0;Size_0;Data_0}, as shown in FIG. 1. Any suitable number of entries can be present in a chunk 102 of cache 100.

In some embodiments, an entry can span two adjacent chunks, such as chunk_0 and chunk_1, chunk_1 and chunk_2, chunk_2 and chunk_3, . . . , and chunk_m and chunk 0. In some embodiments, if there is not enough space available in a chunk (e.g., chunk_1), the entry will be stored in the next chunk (e.g., chunk_2).

In some embodiments, cache 100 can be implemented as a circular cache in which chunks are filled with entries sequentially and chunk_0 follows chunk_m in the sequence. When the cache is full (or about to become full) (e.g., which can be determined based on the cache size meeting or exceeding a given percentage of the cache's capacity), the chunk of the cache with the oldest entries can be erased to make space for new entries, in some embodiments.

A pointer 104 to the next available location in the cache can be maintained in some embodiments.

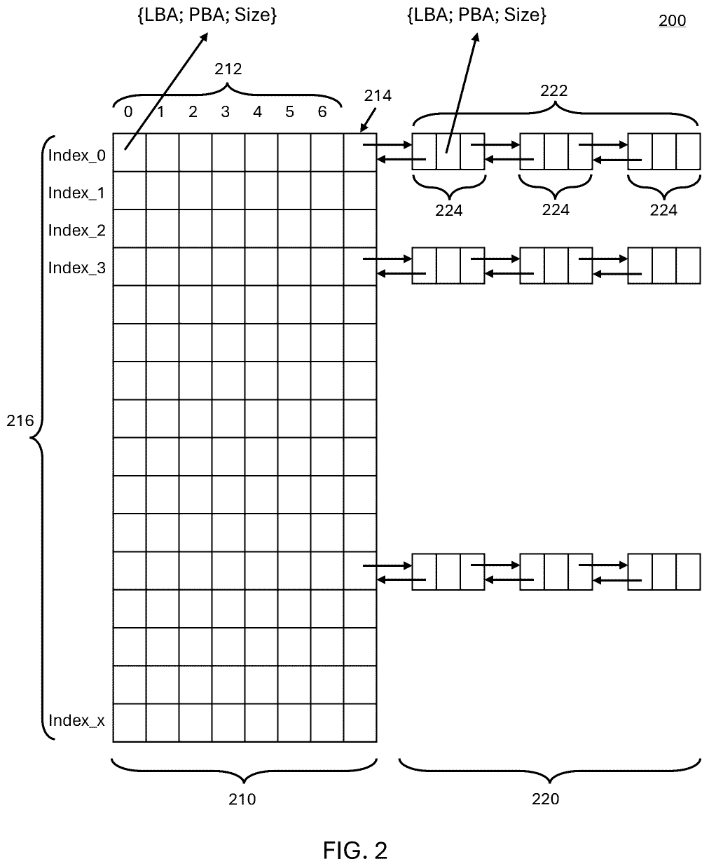

FIG. 2 shows an example illustration of a data structure 200 for keeping track of entries in cache 100, in accordance with some embodiments.

In some embodiments, the data structure can be formed from any suitable type of physical memory, including but not limited to: Random Access Memory (RAM) (such as dynamic RAM, static RAM, etc.); NAND flash memory; NOR flash memory; any other suitable flash technology; phase change memory technology; and/or other any other suitable volatile and/or non-volatile memory storage technology. When using NAND flash memory, any suitable NAND technology can be used in some embodiments. For example, in some embodiments, NAND technologies such as single-level cell (SLC) NAND, multilevel cell (MLC) NAND, triple-level cell (TLC) NAND, quad-level cell (QLC) NAND, penta-level cell (PLC) NAND, or any NAND with suitable levels of cells can be used. In some embodiments, the NAND can be 2D NAND or 3D NAND. Each physical media can have any suitable size in some embodiments.

As illustrated, data structure 200 can have a table portion 210 and zero or more linked-list portions 220, in some embodiments.

In accordance with some embodiments, in table portion 210, a set of slots 212 and a linked-list pointer 214 can be maintained for zero or more indices 216. Table portion 210 can maintain these items for any suitable number of indices 216 in some embodiments.

Any suitable number (e.g., 7 (as illustrated in FIG. 2), 16, 32, etc.) of slots can be provided for each index in table 210, in some embodiments. Each slot can hold any suitable information for the corresponding index, such as an entry with a logical block address (LBA) corresponding to the index, a physical block address (PBA) corresponding to the LBA, and a size of the data stored in the cache for the LBA, in some embodiments.

Linked-list pointer 214 can contain a pointer to a linked-list 222 in a linked-list portion 220 associated with a corresponding index or can contain an indicator to indicate that there is no linked-list associated with the corresponding index.

In some embodiments, each linked-list 222 can include any suitable number of entries 224, and each entry can include any suitable number of fields. For example, in the left entry 224, the left field can be an identifier of the index to which the linked-list belongs, the middle field can hold any suitable information for the corresponding index, such as an entry with a logical block address (LBA) corresponding to the index, a physical block address (PBA) corresponding to the LBA, and a size of the data stored in the cache for the LBA, and the right field can be a pointer to the next entry in the linked-list, in some embodiments. As another example, in the middle entry 224, the left field can be a pointer to the left entry 224, the middle field can hold any suitable information for the corresponding index, such as an entry with a logical block address (LBA) corresponding to the index, a physical block address (PBA) corresponding to the LBA, and a size of the data stored in the cache for the LBA, and the right field can be a pointer to the next entry in the linked-list, in some embodiments.

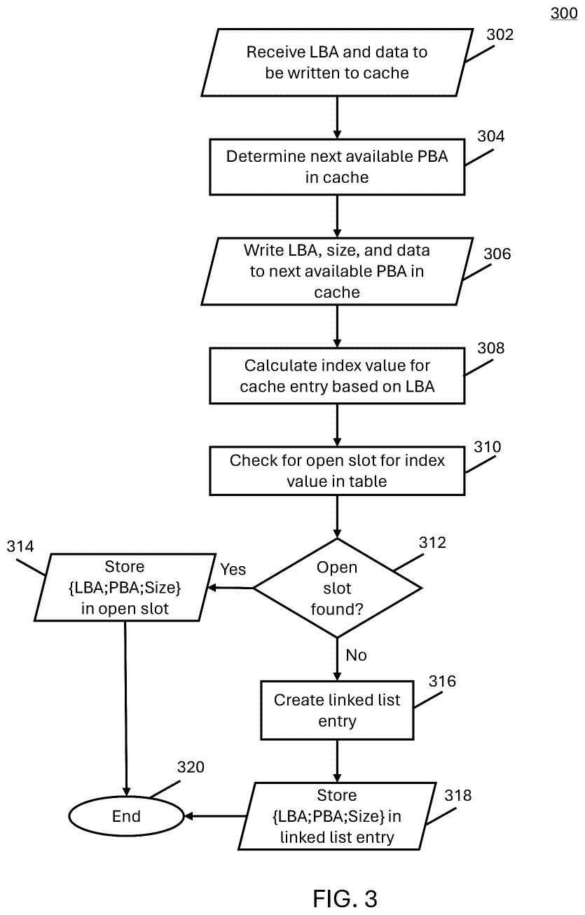

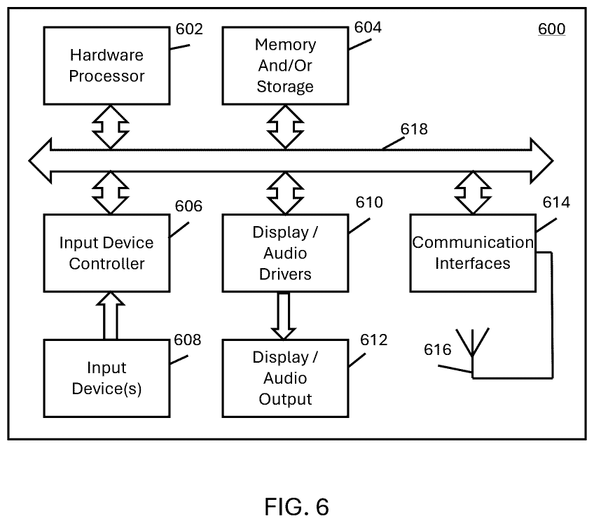

Turning to FIG. 3, an example process 300 for writing to cache 100 in accordance with some embodiments is shown. This process can be executed by a hardware processor, such as hardware process 602 described below in connection with FIG. 6.

As illustrated, process 300 can begin at 302 at which it can receive a logical block address (LBA) and data to be written to the cache. The LBA and data can be received in any suitable manner from any suitable source, in some embodiments. For example, in some embodiments, the LBA and data can be received from a host process that is attempting to store data to the cache.

Next, at 304, process can determine the next available physical block address (PBA) in the cache. This determination can be made in any suitable manner in some embodiments. For example, this determination can be made by accessing pointer 104 of FIG. 1, which tracks the next available location in cache 100.

Then, at 306, process 300 can write the LBA, the size of the data, and the data to the next available PBA in the cache. The LBA, size of the data, and data can be written to the cache in any suitable manner and in any suitable arrangement, in some embodiments.

At 308, process 300 can next calculate an index value for the cache entry written at 306 based on the LBA of the entry. This index value can be calculated in any suitable manner in some embodiments. For example, in some embodiments, this index value can be calculated by applying a hash function to the LBA and using the resulting hash value as the index value.

Next, at 310, process 300 can check for an open slot 216 for the given index value (e.g., index_0, index_1, index_2, etc.) in table 210 of data structure 200. This check can be performed in any suitable manner, in some embodiments. For example, in some embodiments, this check can be performed by sequentially reading each slot for the given index value to determine if any slot is empty.

Then, at 312, process 300 can determine if an open slot was found at 310. If so, then, at 314, process 300 can store the LBA, the PBA, and the size of the data in the open slot. This storing can be performed in any suitable manner and in any suitable arrangement, in some embodiments. If it is determined at 312 that an open slot was not found, then, process 300 can create an entry in the linked-list for the index at 316 and store the LBA, the PBA, and the size of the data in the created linked-list entry at 318.

After completing 314 or 318, process 300 can end at 320.

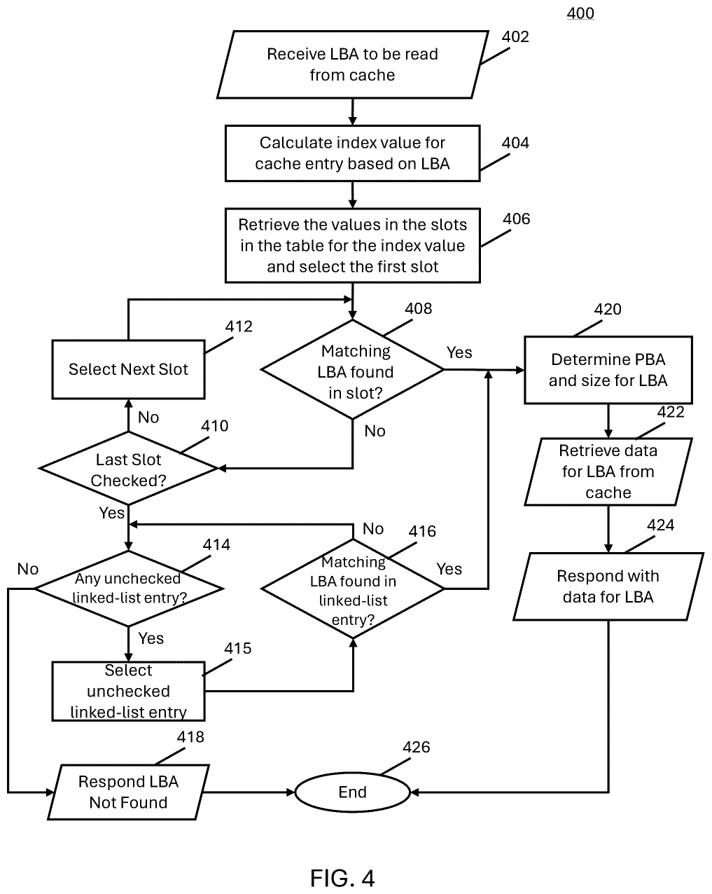

FIG. 4 illustrates an example process 400 for accessing an item in the cache in accordance with some embodiments. This process can be executed by a hardware processor, such as hardware process 602 described below in connection with FIG. 6.

As shown, process 400 can begin at 402 by receiving an LBA to read from the cache. This LBA can be received in any suitable manner from any suitable source in some embodiments. For example, in some embodiments, the LBA can be received from a host process that wants to access data stored in the cache.

Next, at 404, process 400 can calculate an index value for the cache entry based on the LBA. This index value can be calculated in any suitable manner in some embodiments. For example, in some embodiments, this index value can be calculated by applying a hash function to the LBA and using the resulting hash value as the index value.

Then, at 406, process 400 can retrieve the values in the slots in the table for the index value and select the first slot. The values can be retrieved in any suitable manner, and any suitable slot can be selected as the first slot in some embodiments. For example, in some embodiment, slot 0 shown in the table can be selected as the first slot.

At 408, process 400 can then determine if a matching LBA is found in the selected slot. This determination can be made in any suitable manner, in some embodiments. For example, this determination can be made by determining a match when the LBA received at 402 is the same as the LBA stored in the slot.

If it is determined at 408 that a match was not found, then process 400 can proceed to 410 to determine if the selected slot is the last slot for the index determined at 404. This determination can be made in any suitable manner, in some embodiments. For example, in some embodiment, this determination can be made by determining that all slots for the index determined at 404 have been checked. As another example, in some embodiment, this determination can be made by determining that the most-recently checked slot is empty and therefore that any remaining slots should be empty as well. As yet another example, in some embodiment, this determination can be made by determining that the number of slots checked at 408 for the current LBA and index value matches a counter of the slots used for the index value.

If it is determined at 410 that the last slot has not been checked, then process 400 can proceed to select the next slot at 412 and loop back to 408. The next slot can be selected in any suitable manner, in some embodiments. For example, in some embodiments, the next sequentially numbered slot can be selected (e.g.: after slot 0 has been selected, slot 1 can be selected; after slot 1 has been selected, slot 2 can be selected; after slot 2 has been selected, slot 3 can be selected; etc.).

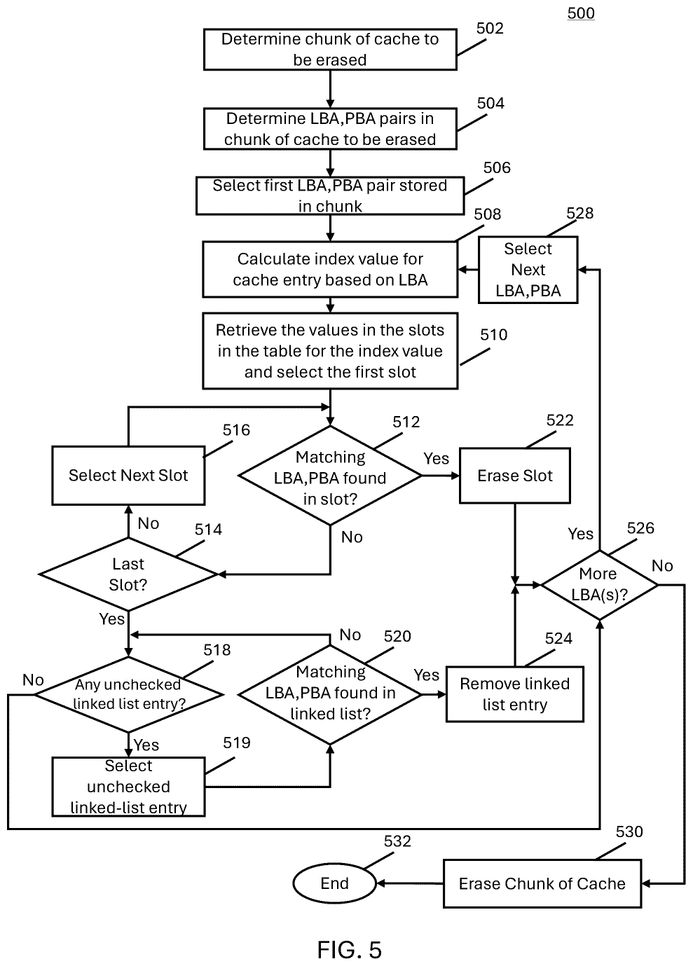

If it is determined at 410 that the last slot has been checked, then process 400 can proceed to 414 at which it can determine if there is an unchecked linked list entry. This determination can be made in any suitable manner, in some embodiments. For example, in some embodiments, this determination can be made by determining if field 214 in table 210 of FIG. 2 is empty or points to NULL. As another example, in some embodiments, if 415 has previously been performed in the present instance of process 400, this determination can be made by determining that the right field in the currently selected link list entry is empty or points to NULL. As yet another example, in some embodiments in which linked-list entries are moved to slots when slot entries are erased at 522 of FIG. 5 (as described below), if the last slot checked at 408 for the currently selected LBA,PBA pair was empty, then it can be assumed that there are no linked-list entries for the present index.

If it is determined at 414 that there is no unchecked linked-list entry, then process 400 can respond to the process triggering process 400 that the LBA received at 402 was not found at 418 and then end at 426. This response can be made in any suitable manner and have any suitable content, in some embodiments.

Otherwise, if it is determined at 414 that there is an unchecked linked-list entry, then process 400 can proceed to 415 at which it can select an unchecked linked-list entry. This selection can be made in any suitable manner and any suitable unchecked linked-list entry can be selected.

Next, at 416, process 400 can determine if a matching LBA is found in the selected linked-list entry. This determination can be made in any suitable manner, in some embodiments. For example, this determination can be made by determining a match when the LBA received at 402 is the same as the LBA stored in the selected linked-list entry.

If it is determined at 416 that there is no match, then process 400 can loop back to 414.

If it is determined at 408 or 416 that there is a match, then process 400 can proceed to 420 at which it can determine the PBA and the size of the data for the LBA from the matching slot or linked-list entry. This determination can be made in any suitable manner in some embodiments.

Then, at 422, process 400 can retrieve the data for the LBA from the cache using the PBA and the size determined at 420. This retrieval can be made in any suitable manner in some embodiments.

Finally, at 424, process 400 can respond to the process triggering process 400 with the data for the LBA received at 402 and then end at 426. This response can be made in any suitable manner and have any suitable content, in some embodiments.

Turning to FIG. 5, an example process 500 for erasing a cache chunk in accordance with some embodiments is shown. As noted above, in some embodiments, a cache chunk may be erased when all other chunks are full or about to become full (e.g., which can be determined based on the cache size meeting or exceeding a given percentage of the cache's capacity). This process can be executed by a hardware processor, such as hardware process 602 described below in connection with FIG. 6.

Process 500 can begin at 502 by determining a chunk of the cache to be erased. This determination can be made in any suitable manner in some embodiments. For example, in some embodiments, this determination can be made by selecting the next chunk after a next available block pointer in the cache as described above in connection with FIG. 1.

Then, at 504, process 500 can determine LBA,PBA pairs in the chunk of the cache to be erased. An LBA,PBA pair can be an LBA and the corresponding PBA of the selected chunk at which the LBA's data is stored, in some embodiments. This determination can be made in any suitable manner, in some embodiments. For example, in some embodiments, this determination can be made by scanning metadata of the selected chunk of the cache with a physical to logical block address mapping to identify LBAs stored at corresponding PBAs therein.

Next, at 506, process 400 can select the first LBA,PBA pair stored in the chunk. This determination can be made in any suitable manner, and any suitable LBA,PBA pair identified at 504 can be selected as the first LBA,PBA pair, in some embodiments.

At 508, process 500 can next calculate an index value for a cache entry based on the selected LBA. This index value can be calculated in any suitable manner in some embodiments. For example, in some embodiments, this index value can be calculated by applying a hash function to the LBA and using the resulting hash value as the index value.

Then, at 510, process 500 can retrieve the values in the slots in table 210 of FIG. 2 for the index value and select the first slot. The values can be retrieved in any suitable manner, and any suitable slot can be the first slot in some embodiments. For example, in some embodiment, slot 0 shown in the table can be selected as the first slot.

At 512, process 500 can then determine if a matching LBA,PBA pair is found in the selected slot. This determination can be made in any suitable manner, in some embodiments. For example, this determination can be made by determining a match when the LBA,PBA pair most recently selected at 506 or 528 is the same as the LBA,PBA pair stored in the slot.

If it is determined at 512 that a match was found, then process 500 can erase or mark empty the slot at 522. The slot can be erased or marked empty in any suitable manner in some embodiments. In some embodiments, instead of or in addition to erasing a slot at 522, process 500 can move the contents of a linked-list entry for the index value to the slot and then remove the linked-list entry, if such a linked-list entry exists. The content of the linked-list entry can be moved and the linked-list entry can be removed in any suitable manner, in some embodiments.

If it is determined at 512 that a match was not found, then process 500 can proceed to 514 to determine if the selected slot is the last slot for the index determined at 508. This determination can be made in any suitable manner, in some embodiments. For example, in some embodiment, this determination can be made by determining that all slots for the index determined at 508 have been checked. As another example, in some embodiment, this determination can be made by determining that the most-recently checked slot is empty and therefore that any remaining slots should be empty as well. As yet another example, in some embodiment, this determination can be made by determining that the number of slots checked at 408 for the current LBA/PBA and index value matches a counter of the slots used for the index value.

If it is determined at 514 that the last slot has not been checked, then process 500 can proceed to select the next slot at 516 and loop back to 512. The next slot can be selected in any suitable manner, in some embodiments. For example, in some embodiments, the next sequentially numbered slot can be selected (e.g.: after slot 0 has been selected, slot 1 can be selected; after slot 1 has been selected, slot 2 can be selected; after slot 2 has been selected, slot 3 can be selected; etc.).

If it is determined at 514 that the last slot has been checked, then process 500 can proceed to 518 at which it can determine if there is an unchecked linked list entry. This determination can be made in any suitable manner, in some embodiments. For example, in some embodiments, this determination can be made by determining that field 214 in table 210 of FIG. 2 is empty or points to NULL. As another example, in some embodiments, if 519 has previously been performed for the selected LBA,PBA pair, this determination can be made by determining that the right field in the currently selected link list entry is empty or points to NULL. As yet another example, in some embodiments in which linked-list entries are moved to slots when slot entries are erased at 522 (as described above), if the last slot checked at 512 for the currently selected LBA,PBA pair was empty, then it can be assumed that there are no linked-list entries for the present index.

If it is determined at 518 that there is no unchecked linked-list entry, then process 500 can branch to 526 and proceed as described below.

Otherwise, if it is determined at 518 that there is an unchecked linked-list entry, then process 500 can proceed to 519 at which it can select an unchecked linked-list entry. This selection can be made in any suitable manner and any suitable unchecked linked-list entry can be selected.

Next, at 520, process 500 can determine if a matching LBA,PBA pair is found in the selected linked-list entry. This determination can be made in any suitable manner, in some embodiments. For example, this determination can be made by determining a match when the LBA,PBA pair most recently selected at 506 or 528 is the same as the LBA,PBA pair stored in the linked-list entry.

If it is determined at 520 that there is no match, then process 500 can loop back to 518.

If it is determined at 520 that there is a match, then process 500 can remove the linked-list entry from the linked-list for the index. The linked list entry can be removed in any suitable manner, in some embodiments.

After performing 522 or 524, process 500 can proceed to 526 at which it can determine if there are any more LBA,PBA pairs from 504 that have yet to be selected at 506 or 508. This determination can be made in any suitable manner, in some embodiments.

If so, process 500 can select the next LBA,PBA pair at 528 and then loop back to 508. This selection can be made in any suitable manner, and any suitable LBA,PBA pair identified at 504 can be selected as the next LBA,PBA pair, in some embodiments.

Otherwise, if it is determined at 526 that there are no more LBA,PBA pairs, then process 500 can erase the selected chunk of the cache at 530 and then end at 532. Erasing the selected chunk of the cache at 530 can be performed in any suitable manner in some embodiments.

It should be understood that at least some of the above-described blocks of the processes of FIGS. 3, 4, and/or 5 can be executed or performed in any order or sequence not limited to the order and sequence shown in and described in the figures. Also, some of the above blocks of the processes of FIGS. 3, 4, and/or 5 can be executed or performed substantially simultaneously where appropriate or in parallel to reduce latency and processing times. Additionally or alternatively, some of the above described blocks of the processes of FIGS. 3, 4, and/or 5 can be omitted.

The mechanisms described herein can be implemented in any suitable computing device. For example, in some embodiments, the mechanisms described herein can be implemented using any suitable general-purpose computer or special-purpose computer(s). For example, the mechanisms can be implemented using server. Any such general-purpose computer or special-purpose computer can include any suitable hardware. For example, as illustrated in example hardware 600 of FIG. 6, such hardware can include hardware processor 602, memory and/or storage 604, an input device controller 606, an input device 608, display/audio drivers 610, display and audio output circuitry 612, communication interface(s) 614, an antenna 616, and a bus 618.

Hardware processor 602 can include any suitable hardware processor, such as a graphical processing unit (GPU), a microprocessor, a micro-controller, digital signal processor(s), dedicated logic, and/or any other suitable circuitry for controlling the functioning of a general-purpose computer or a special purpose computer in some embodiments.

Memory and/or storage 604 can be any suitable memory and/or storage for storing programs, data, and/or any other suitable information in some embodiments. For example, memory and/or storage 604 can include: hard disk storage; optical media; Random Access Memory (RAM) (such as dynamic RAM, static RAM, etc.); NAND flash memory; NOR flash memory; any other suitable flash technology; phase change memory technology; and/or other any other suitable volatile and/or non-volatile memory storage technology. When using NAND flash memory, any suitable NAND technology can be used in some embodiments. For example, in some embodiments, NAND technologies such as single-level cell (SLC) NAND, multilevel cell (MLC) NAND, triple-level cell (TLC) NAND, quad-level cell (QLC) NAND, penta-level cell (PLC) NAND, or any NAND with suitable levels of cells can be used. In some embodiments, the NAND can be 2D NAND or 3D NAND. Each physical media can have any suitable size in some embodiments.

Input device controller 606 can be any suitable circuitry for controlling and receiving input from input device(s) 608, in some embodiments. For example, input device controller 606 can be circuitry for receiving input from an input device 608 such as a touch screen, from one or more buttons (such as on a keyboard), from a voice recognition circuit, from a microphone, from a camera, from an optical sensor, from an accelerometer, from a temperature sensor, from a near field sensor, and/or any other type of input device.

Display/audio drivers 610 can be any suitable circuitry for controlling and driving output to one or more display/audio output circuitries 612 in some embodiments. For example, display/audio drivers 610 can be circuitry for driving one or more display/audio output circuitries 612, such as an LCD display, a speaker, an LED, or any other type of output device.

Communication interface(s) 614 can be any suitable circuitry for interfacing with one or more communication networks. For example, interface(s) 614 can include network interface card circuitry, wireless communication circuitry, and/or any other suitable type of communication network circuitry.

Antenna 616 can be any suitable one or more antennas for wirelessly communicating with a communication network in some embodiments. In some embodiments, antenna 616 can be omitted when not needed.

Bus 618 can be any suitable mechanism for communicating between two or more components 602, 604, 606, 610, and 614 in some embodiments.

Any other suitable components can additionally or alternatively be included in hardware 600 in accordance with some embodiments.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

As can be seen, the mechanisms described herein can be used to improve the performance of a cache, and thereby the performance of any computing device in which the cache is used.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system, comprising:
a memory; and
a hardware processor at least configured to:
store a first entry in a cache;
store a second entry in the cache;
store a third entry in the cache;
calculate an index value that corresponds to each of the first entry, the second entry, and the third entry;
store, in a first table location corresponding to the index value, first information identifying a first location of the first entry in the cache;
store, in a second table location corresponding to the index value, second information identifying a second location of the second entry in the cache;
store, in a linked-list corresponding to the index value, third information identifying a third location of the third entry in the cache;
in response to a request to access the third entry in the cache, compare the request to each of at least part of the first information, at least part of the second information, and at least part of the third information;
determine that the request corresponds to the at least part of the third information; and
retrieve data responsive to the request based on the third information.

2. The system of claim 1, wherein the index value is calculated based on a first logical block address of the first entry, the index value is calculated based on a second logical block address of the second entry, and the index value is calculated based on a third logical block address of the third entry.

3. The system of claim 2, wherein the index value is calculated based on a hash function.

4. The system of claim 1, wherein the cache comprises a plurality of chunks of memory and each of the plurality of chunks contains a plurality of entries, and wherein the hardware processor is further configured to erase a chunk on the cache in response to determining that the cache is determined to be at or above a given percentage full.

5. The system of claim 1, wherein the first information includes a logical block address of the first entry and a physical block address of the first entry.

6. The system of claim 5, wherein the first information further comprises a size of data for the first entry.

7. The system of claim 1, wherein the first entry includes a logical block address of the first entry, data of the first entry, and a size of the data of the first entry.

8. A method, comprising:
storing a first entry in a cache;
storing a second entry in the cache;
storing a third entry in the cache;
calculating an index value that corresponds to each of the first entry, the second entry, and the third entry;
storing, in a first table location corresponding to the index value, first information identifying a first location of the first entry in the cache;
storing, in a second table location corresponding to the index value, second information identifying a second location of the second entry in the cache;
storing, in a linked-list corresponding to the index value, third information identifying a third location of the third entry in the cache;
in response to a request to access the third entry in the cache, comparing the request to each of at least part of the first information, at least part of the second information, and at least part of the third information, using a hardware processor;
determining that the request corresponds to the at least part of the third information, using the hardware processor; and
retrieving data responsive to the request based on the third information, using the hardware processor.

9. The method of claim 8, wherein the index value is calculated based on a first logical block address of the first entry, the index value is calculated based on a second logical block address of the second entry, and the index value is calculated based on a third logical block address of the third entry.

10. The method of claim 9, wherein the index value is calculated based on a hash function.

11. The method of claim 8, wherein the cache comprises a plurality of chunks of memory and each of the plurality of chunks contains a plurality of entries, and wherein the method further comprises erasing a chunk on the cache in response to determining that the cache is determined to be at or above a given percentage full.

12. The method of claim 8, wherein the first information includes a logical block address of the first entry and a physical block address of the first entry.

13. The method of claim 12, wherein the first information further comprises a size of data for the first entry.

14. The method of claim 8, wherein the first entry includes a logical block address of the first entry, data of the first entry, and a size of the data of the first entry.

15. A non-transitory computer-readable medium containing computer executable instructions that, when executed by a processor, cause the processor to perform a method, the method, comprising:
storing a first entry in a cache;
storing a second entry in the cache;
storing a third entry in the cache;
calculating an index value that corresponds to each of the first entry, the second entry, and the third entry;
storing, in a first table location corresponding to the index value, first information identifying a first location of the first entry in the cache;
storing, in a second table location corresponding to the index value, second information identifying a second location of the second entry in the cache;
storing, in a linked-list corresponding to the index value, third information identifying a third location of the third entry in the cache;
in response to a request to access the third entry in the cache, comparing the request to each of at least part of the first information, at least part of the second information, and at least part of the third information;
determining that the request corresponds to the at least part of the third information; and
retrieving data responsive to the request based on the third information.

16. The non-transitory computer-readable medium of claim 15, wherein the index value is calculated based on a first logical block address of the first entry, the index value is calculated based on a second logical block address of the second entry, and the index value is calculated based on a third logical block address of the third entry.

17. The non-transitory computer-readable medium of claim 16, wherein the index value is calculated based on a hash function.

18. The non-transitory computer-readable medium of claim 15, wherein the cache comprises a plurality of chunks of memory and each of the plurality of chunks contains a plurality of entries, and wherein the method further comprises erasing a chunk on the cache in response to determining that the cache is determined to be at or above a given percentage full.

19. The non-transitory computer-readable medium of claim 15, wherein the first information includes a logical block address of the first entry and a physical block address of the first entry.

20. The non-transitory computer-readable medium of claim 19, wherein the first information further comprises a size of data for the first entry.
